(19) United States
(12) Patent Application Publication
(10) Pub. No.: US 2026/0288128 A1
(43) Pub. Date: Sep. 24, 2026

(54) COMMUNICATING INFORMATION REGARDING AN INDUSTRIAL MACHINE TO AN OPERATOR BY USING A COMMUNICATION ASSISTANT THAT IS SPECIFIC TO OPERATOR CONTEXT

(71) Applicant: PAUL WURTH S.A., Luxembourg (LU)

(72) Inventor: Cédric SCHOCKAERT, Wiltz (LU)

(21) Appl. No.: 19/490,211

(22) PCT Filed: Jul. 4, 2024
(86) PCT No.: PCT/EP2024/068891

§ 371 Date: Dec. 4, 2025

(30) Foreign Application Priority Data
Jul. 7, 2023 (LU) LU504692

(51) Int. Cl. G05B 23/02; G06F 16/33

(52) U.S. Cl. CPC G05B 23/0216; G06F 16/33; G05B 2219/25238

(57) ABSTRACT

A computer provides communication assistance to communicate information regarding an industrial machine to an operator. The computer detects an operator context of the operator from context data that it receives from the industrial machine. The computer has data modules adapted to process a query to obtain a response. The computer activates at least one data module from the data modules. according to the detected operator context. When the computer receives a question from the operator, it translates the question to the query and directs the query to one of the activated data modules. The computer also translates the response to an answer and forwards the answer to the operator.

### CROSS-REFERENCE TO RELATED APPLICATIONS

This application is a 35 U.S.C. § 371 National Stage patent application of PCT/EP2024/068891 filed 4 Jul. 2024, which claims the benefit of Luxembourg patent application 504692 filed 7 Jul. 2023, the disclosures of which are incorporated herein by reference in their entirety.

### TECHNICAL FIELD

In general, the disclosure relates to the communication between industrial machines and their operators. More in particular, the disclosure describes a computer-implemented communication assistant that supports the communication between machine operators and machines.

### BACKGROUND

Despite advances in automation, almost every industrial machine requires some interaction with a human operator. Simplified, the machine presents information regarding its internal states to the operator, and the operator reacts accordingly, for example, by controlling the machine.

Traditionally, the machine interacts with the operator via a human-machine interface (HMI). The interface would present information visually (on displays or the like). In addition to that, the interface would eventually issue an audible alarm.

Industry sees a trend to make the interaction more efficient, for example, by using further communication modalities or by enhancing data. For example, the machine may communicate information to the operator orally (with text-to-speech translation). Such an approach encodes information directly into a human understandable form. It therefore allows the machine to communicate information in a granularity that is most suitable to the cognitive ability of the human operator. Simple alarm sounds would not be abolished, but the machine can communicate information at least by short spoken phrases. For example, the interface would have to identify a particular machine state (such as, for example, a failure state) and would have to compose an audio message by assembling pre-defined spoken language records (e.g., “The temperature rises above a critical level!”).

Using “to-speech” technology tailors the information to the operator. For example, the machine would select a natural language that this understood by the operator.

There is a further trend to broaden the temporal range of the interaction. For example, the machine may communicate information relating to the present time, but also relating to the future. Both trends are interrelated. The simplified example would lead to “The temperature WILL raise above a critical level IN ONE HOUR FROM NOW”.

However, there are technical constraints, at least in the following:
Identifying the information to be communicated to the operator is a process that takes time, and this time depends on the nature of the information. For example, raising an alarm based on real-time data is relatively easy and less time-consuming in comparison to predicting potential failure (in the future).
Communicating information to the operator is a process that takes time as well. Signal propagation delays (i.e., data communicated via a transmission network) can be neglected in many cases, but oral communication requires time until a message has been communicated to the operator. Spoken phrases have a certain minimal duration, otherwise they are not understandable for humans.
Enhancing information is a process that takes time as well, for example, by translating between formats (text to speech or the like).

In some situations, the constraints may even amplify each other. For example, if the state would be identified as a potential safety hazard to the operator, the corresponding information must reach the attention of the operator as early as possible.

There is a need to overcome the constraints, as well as to speed up the communication and to make it more precise.

US 2014/0365222 A1 presents a mobile system with speech-based on non-speech-based interfaces for telematics applications. The system processes natural language statements, determines commands to a vehicle and thereby uses context information.

### SUMMARY

A computer executes a computer-implemented method to communicate information regarding an industrial machine to an operator of the industrial machine. The computer has the following modules: context detector, task manager, and query interface. The computer also has access to a plurality of data modules.

In a context-detecting step, the context detector detects an operator context of the operator from context data that the context detector receives from the industrial machine. The operator context is defined by the relation of the operator to the industrial machine and by the function of the operator to control the industrial machine.

In an activating step, the task manager activates at least one data module from the plurality of data modules, according to the detected operator context. This approach can be advantageous because the non-activated data modules would not consume computation resources (such as power, access to memory, shares in CPU and the like).

Upon the query interface receiving a question from the operator, the interface translates the question to a query and directs the query to one of the activated data modules. This approach can be advantageous because the data module does not have to be activated, it is already activated. It has been activated previously. Therefore, the computer would not have to use resources to activate this. Directing the query to an activated data module speeds up the communication, compared to directing the query to a not-yet activated data module. As the computer uses the operator context in the selection of a data module to activate (and eventually to de-activate), the computer activates data modules for that the probability of being used is related to the operator context.

Once it has received the query, one of the activated data modules processes the query to obtain a response. The query interface translates the response to an answer and forwards the answer to the operator. This back-translation harmonizes the communication format: the question from the operator has the same format as the answer to the operator.

Activating the (at least one) data module can comprise any of the following: (i) The task manager can cause loading the data module to the main memory of the computer. The data module acts like a memory-resident program, with the advantage that copying the module from storage to memory is no longer required. (ii) The task manager can establish a data connection from the data module to the machine. The data module therefore receives machine data that represents current operation parameters of the machine, when the question/query arrives, the data module can immediately process it. (ii) The task manager can associate model data (i.e., data to be used by the module) with the to-be-activated data module. (iv) The task manager can instruct the module to start operating, for example, to run a prediction. When a question/query for a prediction result arrives, it would be available already.

Activating the (at least one) data module can comprise to communicatively couple a data source to the at least one data module. The data module can be coupled to a collection of data regarding the past operation of the industrial machine if the data module is adapted to process data from the past. Or, the data module can be coupled to a collection of data regarding the past operation of the industrial machine during a window interval if the data module is adapted to make predictions.

In a context-detecting step, the context detector can receive context data that are updates to previously received context data. The context data come from the industrial machine, and there are update occasions. The following list gives examples:
(i) The context detector can determine that the operator of the industrial machine has changed to a different person. When a working shift begins, operators usually log into the machine (i.e., to the computer that is associated with the machine), and when the working shifts end, operators usually log out. Operators may wear ID tags or similar devices so that the computer can determine which person is the current operator in an alternative way.
(ii) The context detector can determine that the operator of the industrial machine has performed a pre-defined activity with effect to the industrial machine. The context is operator context and therefore operator specific. Different operators may make different decisions, and the state of the machine may change: a component may be switched on (or switched off), the machine may have been stopped by an emergency function and so on.
(iii) The context detector can determine that the operator has changed his or her physical location in relation to the industrial machine. The underlying principle is that operators at different locations may have different requirements to obtain information (regarding the machine), and they may react differently. But information regarding the state (of the machine) may be important for the operator to make a decision. An example is the warning (with the suggestion) to leave the machine, as a measure to address potential safety hazards to the operator. But for an operator in a safe control room, such a warning is not required.
(iv) Similarly, the context detector can determine that the operator has escaped the location of the industrial machine. This is again operator-specific context: data modules that may process data regarding potential safety hazards can be de-activated, but other data modules (that are more specific to operator-less operation) can be activated. Escape data is usually available without the need to install sensors. An open emergency door would usually be reported by data, so that the computer can access that source.
(v) Operators usually wear protective clothing, and the determining that the operator has changed clothing (take it on, or off) or that the operator wears particular clothing is relevant for context. The computer can receive the context data from surveillance systems, and/or from sensors. Data modules that process safety relevant data may be activated (or de-activated) accordingly.
(vi) Last but not least in this representative collection of occasions, the context detector can determine that the operator has changed the language of interaction with the operator interface of the industrial machine. The query interface may have learned (by training) that people switch to their native language, especially in when being scared or when emergency situations occur indeed. That is context data that can be processed as well.

Optionally, in translating the question to the query and translating the response to the answer, the computer keeps data that presents language statements. In that sense, the step translating can be by-passed. When the computer directs the query to one of the activated data modules, the computer directs the query to a data module that processes language statements. The query can be directed to a data module that processes language statements that are selected from the following: language statements in natural language, language statements in artificial language, with the statements coded in alpha-numeric characters, and statements that are derivatives of language statements.

Optionally, in translating the question to the query (and translating the response to the answer), the computer can identify a domain of the question and can provide the answer in the same domain. Such a domain-specific approach-in addition activate or deactivate modules by operator context-may be advantageous in avoiding ambiguity (into the question/answer cycles).

Optionally, in detecting the operator context, the context detector can provide the operator context by classifying context data.

Optionally, after receiving the question from the operator by the query interface, and before translating the question to a query by the query interface, the method-executing computer checks the question for ambiguity. For the absence of ambiguity, the computer continues with translating the question. For the presence of ambiguity, the computer (i) modifies the question according to operator context, (ii) translates the question according to operator context, or (iii) interacts with the operator to obtain further details in follow-up questions.

Optionally, the task manager-in step activating at least one data module from the plurality of data modules-also processes the state of the machine. That means, both the operator context and the machine state influence the activation (or deactivation) of a particular data module. For example, if the machine has the state “in maintenance”, data modules that could perform a prediction for “in operation” states would be deactivated.

A computer program product that, when loaded into a memory of a computer system and executed by at least one processor of the computer system, causes the computer system to perform the steps of the computer-implemented method.

A computer system comprises a plurality of modules which perform the steps of the computer-implemented method. Or, from a different perspective, a computer system is provided as a assistance system to communicate information regarding an industrial machine to the operator of the industrial machine, the assistance system comprise the computer—i.e., the assistant—that executes the computer-implemented method.

A computer-implemented assistance system (an “assistant”) is provided to communicate information regarding an industrial machine to an operator of the industrial machine.

A context detector is adapted to detect an operator context of the operator from context data. The context detector receives the context data from the industrial machine. Data modules are adapted to process a query to obtain a response. A task manager is adapted to activate at least one data module from the data modules, according to the detected operator context. A query interface is adapted to receive a question from the operator, to translate the question to the query and to direct the query to one of the activated data modules. The query interface is also adapted to translate the response to an answer and to forward the answer to the operator.

### BRIEF DESCRIPTION OF THE DRAWINGS

Embodiments of the present disclosure will now be described in detail with reference to the attached drawings, in which:

FIG. 1 illustrates-symbolically-an industrial machine as well as a machine operator;

FIG. 2 illustrates a block diagram of a computer-implemented communication assistant, with modules;

FIG. 3 illustrates a step-sequence overview for the operation of the communication assistant, among them a method to communicate information;

FIG. 4 illustrates a machine of a first type, a machine of a second type, and illustrates data that is type-specific as well as data that is type-common;

FIG. 5 illustrates a simplified flow-chart by that the method to communicate information can be modified;

FIG. 6 illustrates a flow-chart for optional sub-steps for the operation of the query interface; and

FIG. 7 illustrates a generic computer.

### DETAILED DESCRIPTION OF THE DRAWINGS

### Fictitious Example

The description explains how a computer-implemented communication assistant enables so-called informative communication between a machine and its operator. The description will occasionally refer to a much simplified example. A human machine operator should perceive some non-typical machine noise and should ask the assistant “when we had such noise the last time?”.

The computer processes a question from the operator as a query to a data module, and processes a response from the data module to an answer. In the example, the computer would answer “last week, but don't worry”.

Here, the computer provides the answer (“last week”) but also adds a detail that may be relevant for the technical operation of the machine as well (“don't worry”).

### Industrial Machine with Operator Interface, Context Data

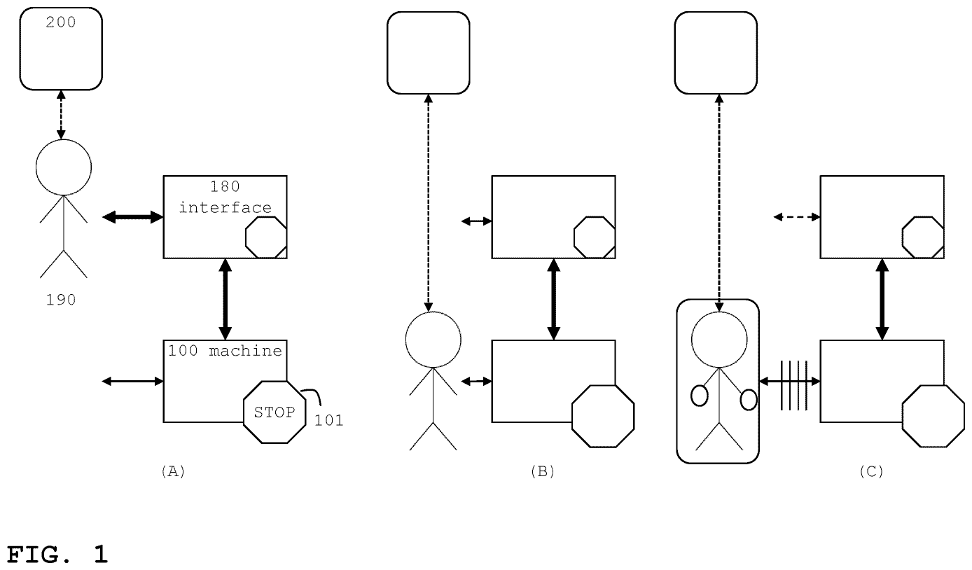

FIG. 1 illustrates—symbolically—an industrial machine 100 as well as machine operator 190. (To be short, the description will write “machine” and “operator”.)

Unless indicated otherwise, machine 100 is a particular machine that is located at a particular industrial site, and operator 190 is a particular natural person.

Operator 190 stands for a function role, a change of the person of operator 190 does not interrupt the operation of machine 100.

Communication (between machine 100 and operator 190) is provided by the following interfaces:
operator interface 180 (in short “interface 180”) being a traditional human-machine interface (HMI, bi-directional communication),
emergency stop 101 (“stop” in short, unidirectional to the machine only, often implemented as a red mushroom, or as a cord), and
context-specific communication assistant 200 (or simply “assistant”, bi-directional).

FIG. 1 has three parts to differentiate three scenarios (A), (B) and (C), but for simplicity, the references 100/101/200/180/190 are given for scenario (A) only.

From a high-level perspective, communication can be differentiated into:
control communication via interface 180 (and eventually via stop 101) to let operator 190 control machine 100, and
informative communication via assistant 200 to let operator 190 obtain further information, in many situations in the question-and-answer scheme (cf. the above-explained example).

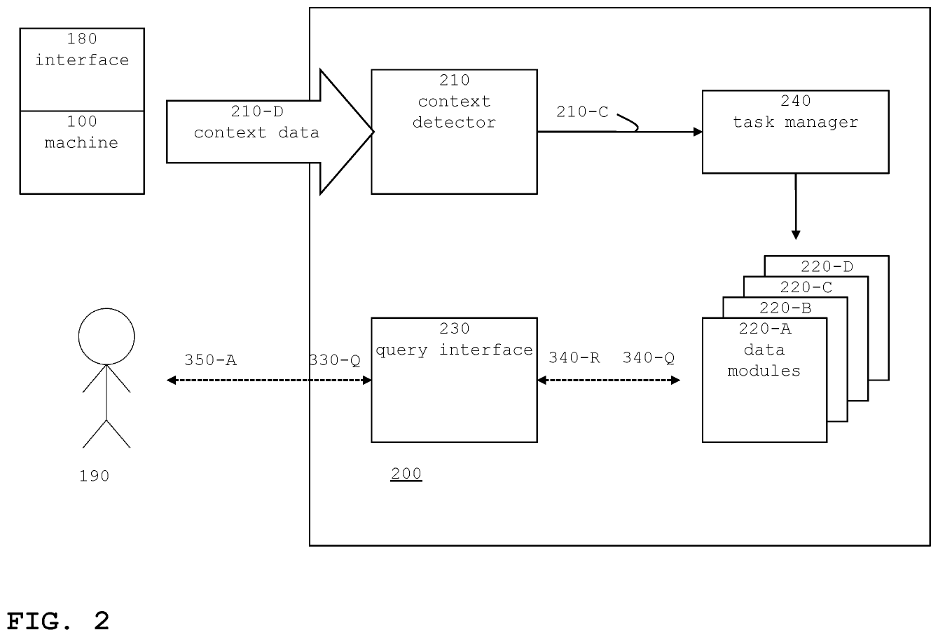

The operation of assistant 200 is specific to context, and the description explains how the context can be identified. As used herein, context is operator context, and the data that allows the identification of this operator context is called “context data” (cf. 210-D in FIG. 2).

### Occasions for Questions and Answers

Operator 190 may ask assistant 200 at substantially any time, but it can be expected that
operator 190 would ask in scenarios (A) and (B) only occasionally,
operator 190 would ask in scenario (C) with relatively higher probability (due to some constraints in the control communication),
operator 190 would ask in scenarios (A), (B) or (C) if he would have the impression that machine 100 (or a component) shows a failure,
assistant 200 would contact operator 190 after detecting an emergency stop event (an initial question would come from the assistant).

### Control Communication and Informative Communication

Double-arrows symbolize control communication, but FIG. 1 also symbolizes a preference: bold arrows (e.g., between operator 190 and interface 180, and between machine 100 and interface 180) stands for usual control communication, and thin arrows (e.g., between operator 190 and machine 100) stand for control communication that occurs less frequently (or for communication that conveys less information).

Control communication is related to controlling machine 100 (that performs a process or the like). The stop sign (reference 101) illustrates a special control case: operator 190 can cause the machine to stop (such as in emergency situations).

In other words, machine 100 has interface 180, and—if required by safety standards —machine 100 also comprises emergency stop 101. Stop 101 is an optional component, but as almost every machine 100 have such stop 101, the description assumes its presence.

Assistant 200 can use information from interface 180 (and from stop 101), but operates without interfering with them. In other words, assistant 200 is not provided to control the machine. Control communication and informative communication are separate topics. Operator 190 can use informative communication to learn more about the machine, about its technical states for example. Operator 190 can than make a decision how to proceed with control communication. In other words, assistant 200—as its label suggests—assists operator 190 in making a decision that involves the control of the machine.

The above-mentioned constraints can be discussed with FIG. 1 as well, and considering context in combination with assistant 200, at least partially, is part of the solution.

### Operator Context

Control communication is related to operator context, and—from a high-level perspective—the operator context can be described, for example and without the intention to be limiting,
by a communication modality, between interface 180 and operator 190,
by the physical location of operator 190 relative to interface 180, and relative to machine 100,
by operator specifics, such as a degree of familiarity of operator 190 with the machine, a measurable health condition of operator 190 (e.g., skin resistance, heart rate, this is still in relation to the machine because operators in problematic health condition may tend to operate the machine incorrectly).

The operator context is defined in relation by the relation of the operator to the industrial machine, and in the function of the operator to control the machine. Therefore, properties of the operator that are not related to this control function are not defined as operator context (for example, his or her name).

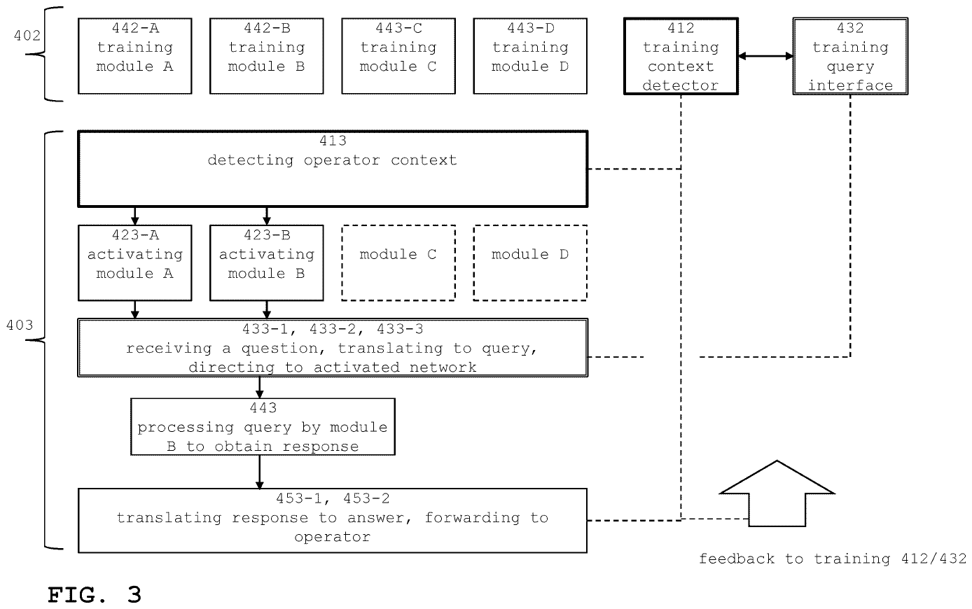

A computer (that is associated with communication assistant 200) can collect context descriptors at substantially any time, and can detect an operator context (cf. FIG. 2 context data 210-C). An example for a context detector (or context determiner) will be explained for FIGS. 2-3. Depending on the context, machine 100 (i.e., interface 180) can interact with operator 190 differently (the interaction is context sensitive), but—as it will be described—the context is more related to the operation of assistant 200.

Regarding the modality, the control communication can use different modalities, usually in combination. Examples comprise the following:
(visual communication) Operator 190 looks at interface 180, and/or looks at machine 100.
(audible communication) Operator listens 190 to the sound of machine 100, or hears alarm sounds issued by interface 180, etc.
(haptic) Operator 190 touches a keyboard or a touch-screen of interface 180. Operator 190 may eventually use stop 101.

The modalities may be interdependent. In a simplified example, operator 190 may not be able to listen to machine 100 if he is located in the control room. The same applies for alarm sounds if they could be recorded in one location only.

It is noted that the modalities can be used as context data (cf. 210-D) as well. In other words, the modality by that machine and operator communicate to control the machine can determine how the assistant answers to questions. To cite the example, operator 190 hears the noise, and communication assistant 200 may therefore provide the answer not only by text-to-speech or similar audio messages, but—taking the noisy environment into account—by repeating the answer on a display.

Regarding the location, as illustrated by variants (A) and (B), operator 190 may be located near interface 180 (for example in a control room), or operator 190 may by located near machine 100. The availability of interface 180 at machine 100 may be limited (the control room usually has more data), and in a simplified situation, the only option for operator 190 may be to use stop 101.

The skilled person is able to track the location of operator 190 so that location data can be used by the context detector. For the above example, it may make a difference if the operator becomes aware of the noise from the control room (A) or directly from the machine (B). In case (A), the noise may come from elsewhere but not from the machine.

In both variants, the operator could physically change the location:
From scenario (A) to scenario (B): Operator 190 could leave the control room to inspect machine 100 (but would have less opportunities to use interfaces that are located in the control room).
From scenario (B) to scenario (A). Operator 190 could return to the control room.

Again, the same principle applies, the context detector would evaluate a change in the physical location as a change in context. Consequently, assistant 200 may communicate with operator 190 differently if he is located in the control room (A) or near the machine (B).

Regarding the operator specifics, by operator specifics, operator 190 may select a particular natural language for interface 180.

### Control by Emergency Stop

It may happen that the control communication becomes extremely simplified. Operator 190 may instruct machine 100 to stop. Operator 190 would avoid the stop whenever possible, for a number of reasons: the machine may take time to resume normal operation. Of course, in some emergency situations, operator 190 may try to run away, without interacting with the machine, and potentially without stopping it.

A stop event (i.e., operator 190 acted on stop 101) is an information that changes the context. In other words, the detected stop event can cause assistant 200 to communicate with operator 190 in a particular way.

In the example, the assistant may add “do not worry” because an earlier occasions, noise had encouraged a different operator to stop the machine.

### Control Under Complicated Circumstances

Variant (C) illustrates a situation in that control interaction is more complicated compared to (A) and (B).

As operator 190 is located near machine 100 as in (B), he could wear gloves and/or protective clothing. FIG. 1 symbolizes this by a “round” rectangle around the operator symbol.

The environment of machine 100 could be characterized by sounds, dust, darkness, humidity, hot air etc. FIG. 1 symbolizes this by a vertical lines over the communication arrows.

As a consequence, control communication might have some challenges.
Visual communication might be complicated. Operator 190 may look at machine 100, but the visibility of displays or the like might be poor.
Operator 190 listens to the sound of machine 100, but there are other sounds as well, and hearing communication via audio-enabled components of interface 180 (via head-phones or the like, also phone with other operators) is limited.
The gloves make it difficult for operator 190 to use a keyboard or the like, (haptics). Interface elements, even if adapted for gloved handed offer less opportunities than normal interface elements.

These (and other) challenges can be used as context descriptors (for assistant 200). Sensors can represent visibility by data, can measure the environmental sound level, can measure vibrations, can determine what clothing the operator wears, etc.

### Machine Operation and the Need for Further Information

Despite the complications in the interaction, FIG. 1 (A), (B), (C) refer to operation modes of machine 100 that are “normal”: the machine performs an industrial process as scheduled, there is no malfunction (of the machine or of a part of the machine).

However, some functions of machine 100 may be unusual, operator 190 would have realized that something has changed. Operator 190 may perceive that machine 100 might operate abnormally. Operator 190 seeks to obtain further information. In the example, it is the unknown noise that lets the operator ask.

Depending on the location, the perception (and the options to react) are different. Again, an extreme reaction (emergency stop) should be avoided. The operator needs time (and reliable information) to evaluate the situation. Again, further information, even information that is not (yet) available from interface 180 (or available but difficult to catch) would be helpful.

In scenario (A), interface 180 would indicate a lot of data, and operator 190 could eventually select software components (such as prediction module etc.) that perform an evaluation. In scenario (A), there should be no immediate danger (or safety hazard) to operator 190. In scenario (A), operator 190 has potentially sufficient time and opportunities to manually identify the information that is needed.

In scenarios, (B) and (C), interface 180 would still indicate data at least for some elements that the operator can see at machine 100, but operator 190 is away from the control room. But even he holds a most sophisticated interface (in a mobile device), only some data would reach him. The operator is potentially in a dangerous area. The operator may perceive a “save and sound” situation as a potential hazard.

The perception (and the options to react) are different also in view of the time. Regarding a timing aspect (that might be regarded as belonging to context as well), the following should be noted:

In scenarios (B) and (C), operator 190 relocating to (A) takes some time ΔT_ESCAPE, in case of (C) the way away from machine 100 may be obstructed. so ΔT_ESCAPE may be longer in (C) than in (B). In other words, the computer can determine how long a potential escape would take.

### Solution Aspects

Having explained industrial machine 100 with a focus on operator context and having highlighted that operator 190 can be faced with information deficits, the description now explains a solution.

As it will be explained, the solution has a number of interrelated aspects, at least in the following:
Informative communication applies communication by natural languages as the modality. (At least, the communication uses languages that are based on natural languages. Applying other modalities is still possible.)
As the language modality requires computers to (technically) process languages (instead of, for example, data that comes from buttons or keys of machine 100 or of interface 180), the computer needs additional processing time. To deal with that constraint, the data modules that potentially provide information are activated according to the probability of being used. They are activated even before the operators raises the question.
Operator context (that can be collected at substantially any time) acts as the discriminator to select (or to de-select) particular data module. This approach may be advantageous to save computation (memory and energy consumption by activated modules). The mentioned probability by that a data module would be used is related to operator context. The data module is more likely to provide a response if it would fit to the operator context, or a data module is more likely to fail if it would not fit.
As communication of data in language format has inherently some constraints with ambiguity, the operator context is also be used—in a synergistic way—to remove ambiguity.

### The Example Revisited

It takes the assistant some time to decompose the question (“when we had such noise the last time?”), to identify the next activities, such as to
to select data from the past, that means from “last time” (and not for the future),
to identify the need to measure or classify the current sound of the machine (“such noise”, that is the noise that machine makes when the operates raises the questions), and to match that sound to historic records (i.e., by representing sounds in computer-identifiable data).

In the example, operator context can be the following: (i) the location of the operator in hearing distance to the machine (that would identify the machine), (ii) the experience of the operator (e.g., a person who started to operate this machine recently), (iii) the information that a noise even led to a stop in the past, etc.

Except context under point (iii), the operator context can be determined before the operator raises the question.

Assistant 200 may therefore inspect the records to identify the absence of a hazards (i.e., a trigger to the extra message) that also avoids a stop instruction.

### Communication Assistant

FIG. 2 illustrates a block diagram of communication assistant 200 with modules 210, 220, 230 and 240.

Context detector 210 is communicatively coupled to machine 100 and to interface 180 (cf. FIG. 1). Optionally, context detector 210 is coupled to a database (that is not illustrated). Context detector 210 is adapted to monitor operator 190 and to detect operator context 210-C. Technically, context detector 210 receives context data 210-D as the basis for such detection. As context data 210-D usually comprises more data entries than operator context 210-C, context detector 210 can be implemented as a classifier: context 210-C is a classification (that decreases the granularity of context data).

Data modules 220 are adapted to process data (such as machine data, data that represents operation parameters of the machine, etc.). From a high-level perspective, data modules can provide output information that relates
to the past,
to the present (i.e., current operation) and
to the future.

Data modules 220 can be, for example prediction modules (to predict the behavior of machine 100 for a time point in the future), or can be data retrieval modules (to identify data that is related to the operation of machine 100 in the past, at present or in the future). An example, for a data retrieval module with output data for the future would be a module that accesses a maintenance plan.

The skilled person can select suitable data modules, for example, by implementing them by databases, by database management programs, by database middleware, by computer applications that interact with databases (or equivalent data sources) or otherwise.

Data modules 220 can be implemented by machine-learning tools, such as by artificial neural networks (ANNs). Merely by way of example, the following reference in relation to industrial machines is cited: WO 2022/258835 A1 by Cédric Schockaert et al. for an approach that applies prediction to schedule machine maintenance.

Data modules 220 can be implemented by applications that are simulators, by way of example, the following reference is cited.
WO 2022/069498 A1 by Cédric Schockaert et al.

Simulation can be used as a further approach to predict the behavior of machine 100 for a time point in the future.

Data modules 220 can have the further function to be recommenders. Data modules can identify an action that previous operators have taken in similar situations (based on data). Recommending differs from predicting. Recommendations refer to operator actions. For example, a predictor module could predict a particular failure und certain operating conditions (e.g., particular temperature of pressure parameters), and a recommender would suggest the operator to avoid such operating conditions. For example, a data module acting as recommender could suggest to touch the emergency switch (or not to touch it), to schedule maintenance, to replace a particular spare part.

The skilled person is able to limit data processing by the data modules to particular time intervals. Modules to predict (and/or to recommend) events for the future, take data from the past into account. But the past data is limited to the co-called “temporal context window” or simply “window”, and the prediction to the future is limited in time as well.

Data modules 220 can be implemented by so-called chatbot functions. The functions would be domain-specific and context-specific (to be activated, or de-activated).

Data modules 220 form a plurality, and individual modules in that plurality are differentiated by letters 220-A, 220-B, 220-C, and 220-D.

Query interface 230 is adapted to
convert question 330-Q from operator 190 in language format (“when we had . . . ”) to computer-readable format (query 340-Q that can be processed by modules 220-A, 220-B, 220-C and 220-D), and
to convert response 340-R from the data modules to language format, answer 330-A going to operator 190.

Using questions and answers in language format has an ambiguity constraint. Simplified, one and the same word can have different meanings. In the example, the noise question raised by operator 190 of machine 100 has a different meaning than literally the same question raised when the operator is located at home and would be exposed to music made by neighbors.

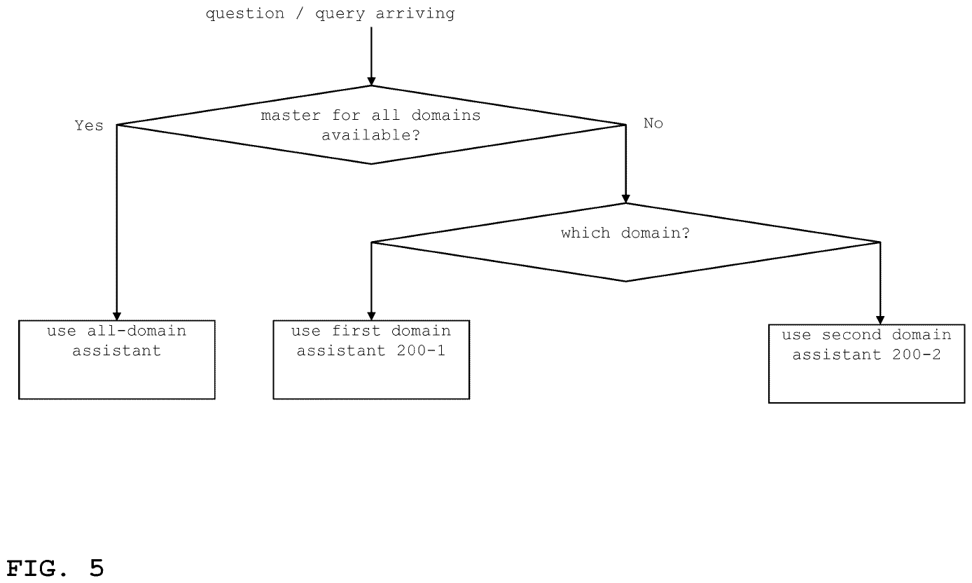

Technically, query interface 230 can resolve ambiguity, for example by taking context data into account (operator context, and also machine context, cf. also domain specific details, cf. FIG. 5).

Assistant 200 further comprises assistant-internal task manager 240 that coordinates the operation of context detector 210, data modules 220, and query interface 230 to perform the computer-implemented method. FIG. 2 illustrates the operation of task manager 240 only symbolically: it receives operator context 210-C, it selects data modules (cf. the vertical arrow), it routes query and responses (routing not illustrated).

The method will be summarized with FIG. 3 as a method 403 to communicate information regarding industrial machine 100 to operator 190 of industrial machine 100.

Implementing context detector 210, data modules 220, query interface 230 with (to be) trained neural networks is convenient.

### Steps

FIG. 3 illustrates a step-sequence overview for the operation of communication assistant 200. As assistant 200 is implemented by a computer, the step-sequences can be considered as belonging to computer-implemented methods 402 and 403. The description refers to the acting entity as the “computer”. It is noted that this is a simplification: the execution of the steps can be distributed to different physical computers.

There are two two sequences at different phases:

Reference **2 marks the training phase (collectively, method 402), with
steps 442 (train data module 442-A, to train data module 442-B, etc.),
step 412 train context detector 210, and
step 432 train query interface 230.

Training is only required for modules that apply machine-learning. Reference **2 therefor stands for setting up modules in general, such by selecting particular data (e.g., particular variates in multi-variate time-series), setting particular time-intervals, etc.

Reference **3 marks the so-called operation phase (or method 403), being a phase that coincides with the operation of machine 100 (and with the control interaction).

In step 413, the computer monitors operator 190 (i.e., by receiving data from machine 100) and thereby detects operator context 210-C. More in detail, context detector 210 detects operator context 210-C from context data 210-D that it receives from machine 100 (optionally from interface 180, cf. FIG. 1). Depending on the context, the computer activates a sub-plurality of data modules (here modules A and B from the plurality A, B, C, and D)

In step 423, the computer activates data modules (e.g., A and B), for example by loading them in main memory (and subsequently running them). The figure symbolizes activated and running data modules by plain lines, and symbolizes de-activated (not-yet-activated, or de-activated) data modules by dashed lines. More in detail, task manager 240 activates at least one data module 220 from the plurality of data modules, in the example of the figure these are data modules 220-A and 220-B.

In other words, activated data modules are in a “stand-by mode” that can immediately start receiving a query, and de-activated data are in an “off mode” that could start receiving the query after “warming up” (but that takes TIME_TO_ACTIVATE).

Steps 413 and 423 are repetitive steps, the sequence 413/423 is performed continuously. When the computer detects a context change, it may activate (previously de-activated) data modules, and de-activate (previously activated) data modules.

In step 433 (with sub-steps -1, -2, -3), the computer receives a query (from operator 190, cf. FIG. 1, the dashed vertical arrows, going up) and identifies a data module (from the plurality) that could provide the response. (The computer uses the query interface, cf. FIG. 2, but FIG. 3 omits the details). In the example, the identified data module would be data module 220-B. Data module 220-B is already running (cf. step 423), there is no time lost to start it. More in detail, when query interface 230 receives (step 433-1) a question from operator 190, it translates (step 433-2) the question 330-Q to query 340-Q and directs (step 433-3) query 340-Q to one of the activated data modules. In the example, this is data module 220-B.

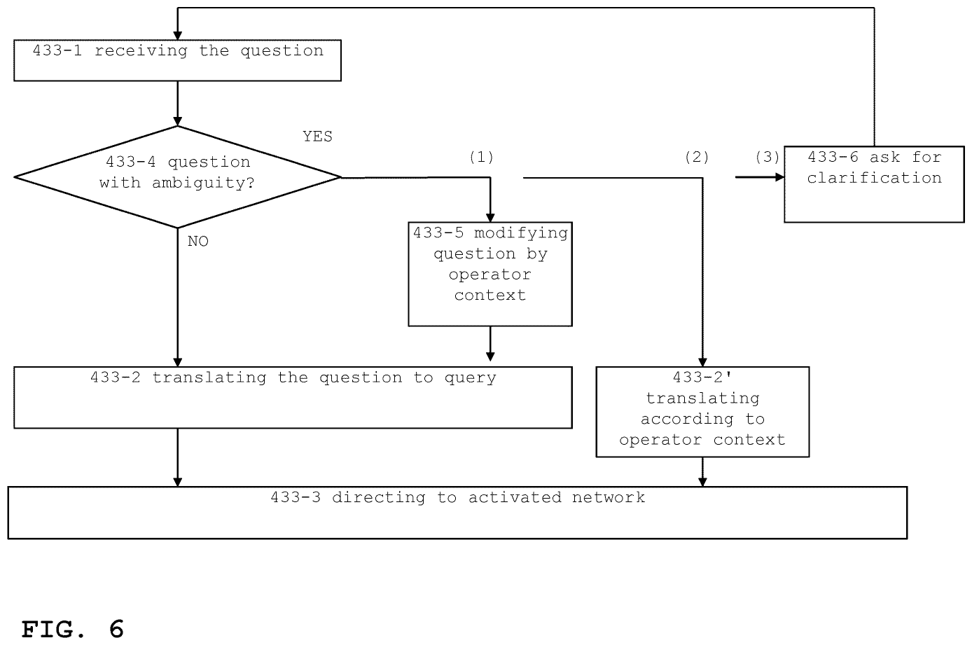

Step 433 can have further sub-steps, with examples to be explained below with FIG. 6.

Activating a data module requires processing time TIME_TO_ACTIVATE, but activating the data module according to context is related to the probability that a question can be answered by an activated module. In this case TIME_TO_ACTIVATE does not belong to the overall processing time. This technical effect can be advantageous, especially in situations in that operator 190 needs the response immediately. (In the above example, the noise may be an indicator of a safety hazard and the answer could be the recommendation to the operator (or other persons) to escape. It is self-explaining that such “high-speed” answers are highly desired).

It is also possible that the computer identifies a data module that is not yet running (cf. step 423) and in such case, the computer would start it running (i.e., during TIME_TO_ACTIVATE). As the context (cf. step 413) is related to the selection of a data module to run initially (step 423), the probability to have a running data module may be higher than the probability to start a data module.

Step 443 stands for one of the activated data modules to process query 340-Q and to obtain response 340-R.

In step 453, the computer interacts with operator 190, by using the query interface to obtain response 340-R from the identified data module (e.g., from B), and to provide the response to operator 190 (e.g., by translating to answer 350-A in a language format).

Optionally, the computer performs step 453 by taking the context into account as well.

Optionally, the computer implements a feedback loop (the large arrow to the top, to the training steps 412 and 432.

### Feedback

Questions from operator 190 might not find answers. There can be many reasons: the data modules may not have access to sufficient data, the questions may not be translatable to queries, the responses may not be translatable to the answer.

It is however possible to continuously re-train the modules. FIG. 3 uses a large up-going arrow as a symbol to illustrate feedback. Step forwarding 453-2 the answer to the operator can comprise to receive feedback from the operator. To stay with the example, an answer “four years ago” might not be helpful for the operator, but feedback might help, for example, to let task manager 240 to fine-tune the time interval for that the data modules process data. The technical effect of the feedback can be seen, for example, as the provision of annotations. Simplified, an affirmative feedback can serve as a positive annotation (i.e., data and data processing leads to a correct answer), or server as a negative annotation.

### Transition

Having described method 403 (and the training in method 402) for a particular machine and for assistance to a particular operator, the description now continues with
differentiating machines 100 according to machine types, and
considering machines of the same type as belonging to machines fleets.

### Sub-Domains

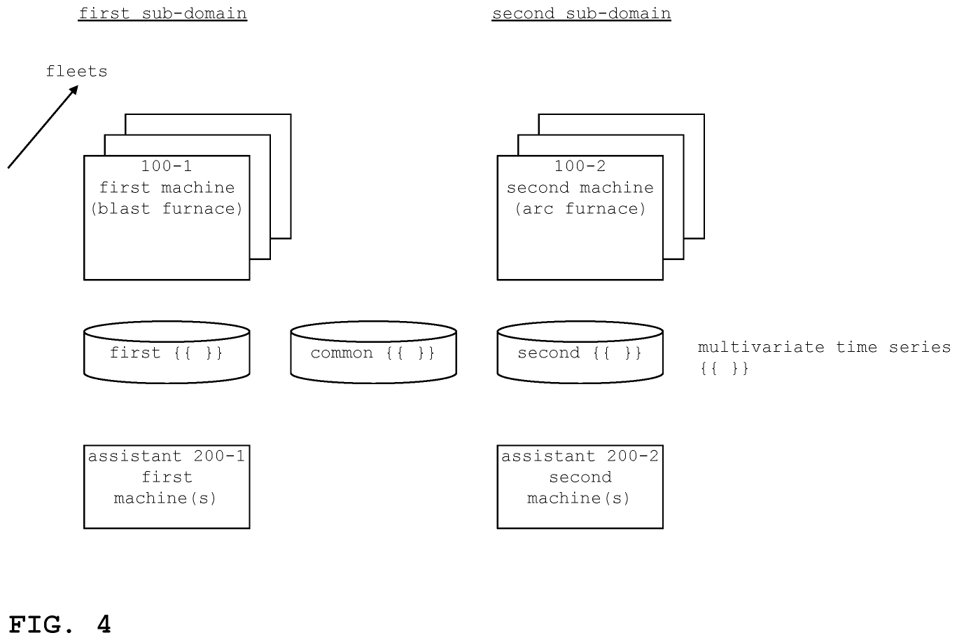

FIG. 4 illustrates a machine 100-1 of a first type, a machine 100-2 of a second type, as well as illustrates data that is type-specific (first and second type data), and that is type-common.

Machine 100-1 is a machine of a first type (e.g., a blast furnace), and machine 100-2 is a machine of a second type (e.g., an arc furnace). Both have some properties in common, such as their use to produce metals. However, there are differences. In other words, both machines 100-1 and 100-2 belong to different sub-domains of the overall domain metal-making equipment.

Data is available as multi-variate time-series {{ }}, no matter if data applies to past, present or even future times. Some variates are common, for both domains. For example, a common variate indicates (i) the state of the metal in the furnaces to be liquid or solid, (ii) the temperature inside the furnace, (iii) the amount of materials (e.g., iron and/or iron ore), etc. Some variates are sub-domain specific, such as current and voltage of the arc are measured for machine 100-2 only.

Therefore, assistant 200-1 could be set up for machine 100-1 and assistant 200-2 could be set up for machine 100-2. But both assistants 200-1 and 200-2 would have some functionality in common. For example, a data module to deal with emergency switch activities could be identical (because each machine has one switch), data modules to predict temperature would have the same structure (although they would be trained differently, sub-domain specifically), question/answer translating would be similar (if not even identical, the noise examples applies to both), etc.

Context detector 210 (cf. FIG. 2) would establish context 210-C differently for both sub-domains. The same natural person could alternatively be the operator for the blast furnace or for the arc furnace (potentially be an expert for “blast” but a beginner for “arc”, or vice versa). But part of the information to establish operator context would be the same for both functions (e.g., the language must be French, not English).

Similarities (and common data) allow to implement assistants 200-1 and 200-2 with common modules. In other words, cf. FIG. 2, a cross-domain assistant 200 could be implemented with context detector 210 with rules that are partly machine-specific, data modules could be split into candidate sub-pluralities (for activation in step 423, some for the first domain only, some for the second domain only, some for both domains), query interface 230 would potentially see only very minor modifications (for example, an operator question regarding arc electricity from a furnace operator would be ignored).

### Software as a Service

FIG. 4 also illustrates that machines of both types can be available in pluralities, or “fleets”, here symbolized by overlapping rectangles. A particular industrial site would have multiple blast furnaces, or would have multiple arc furnaces. Assistant 200 receives context data 210-D and interacts with its users (i.e., the furnace operators) by questions and answers, that means by data. The skilled person can arrange data transmission to and from a centralized computer that provides assistant 200, in a software-as-a-service (Saas) arrangement.

### Hierarchy

FIG. 5 illustrates a simplified flow-chart by that the method to communicate information (such as method 403 in FIG. 3) can be modified.

The relatively high number of machines (two or more machine types or sub-domains; as well as the fleet members) of FIG. 4 contrasts to a relatively low number of assistants (e.g., as in FIG. 4 one assistant 200-1 for blast furnaces, one assistant 200-2 for arc furnaces). As already mentioned, it is possible to reuse some of the modules.

A context-driven workflow can be established to select a computer module that provides the response (i.e., the answer after translation). Arranging the modules in hierarchies can save computation efforts.

As in FIG. 5, a question that arrives (cf. receiving step 433-1 in FIG. 3) could be processed by a so-called master assistant (or general assistant, i.e., by an assistant with data modules that would respond). If such a general assistant is available, it can be used (cf. use all-domain assistant). The same applies if the question has already been translated (step 433-2) to the query.

Also in FIG. 5, in case that a general assistant is not available (for the particular question or query), the domain could be identified (as domain or sub-domain), and the processing would be handled by the first domain assistant 200-1 or by the second domain assistant 200-2 (cf. FIG. 4).

The identification of the sub-domain can be implemented by linking the origin of the question to a particular machine. The person who raises the question is the operator of a particular machine for that the (sub) domain is known to the assistant. The skilled person is familiar with data-binding techniques so that further explanations are not required here.

Assistants 200-1 and 200-2 can share the access to activated modules. This is related to activating step 423 (cf. FIG. 3). Potentially there are contexts that allow to keep some modules activated most of the time. Or, before de-activating a particular module for use by assistant 200-1, the task managers in both assistants can eventually keep that module activated because the context in assistant 200-2 would trigger its activation.

It is also possible to implement cross-domain checking. For example, questions regarding the future (i.e., questions that would use activated prediction modules) would be directed to (activated) prediction modules.

FIG. 6 illustrates a flow-chart for optional substeps for the operation of query interface 230 (cf. FIG. 2).

As already shown and described with FIG. 3, interface 230 performs sub-steps 433-1 (receiving the question), 433-2 (translating the question to the query) and 433-3 (directing the query to an activated network).

One or more of the following may occur:
Question 330-Q (cf. FIG. 2) cannot be translated to query 340-Q because query interface 230 may not have been trained for a particular phrase, for a particular language or the like (cf. step 432 training, in FIG. 3).
Question 330-Q can be translated to multiple queries (not a single query 340-Q).

Such a situation is considered as the presence ambiguity within the question, but the computer can check that. Detecting ambiguity from phrases (in natural language) is known in the art. It is useful to consult a pre-print “Improving Language Understanding” by Generative Pre-Training by Alec Radford et al. It is available from the research laboratory OpenAI on its website (openai.com) and from Semantic Scolar (Corpus ID: 160025533).

For detected ambiguity, the method-executing computer (i.e., with its query interface 230 or with a further modules that communicates with interface 230) can perform further steps (between receiving 433-1 and directing 433-1).

The steps are here given by examples only:
In case (1), the computer can modify 433-5 the question by taking the operator context into account (known from step 413, cf. FIG. 3).
In case (2), the computer can keep the question unchanged but can formulate the query according to operator context (in translating 433-2′ translating according to operator context)
In case (3), the computer can raise a question (or a statement) that is directed to the operator (i.e., in general, the computer can ask for clarification 433-6). In such case it can be expected that the operator raises an updated question so that the computer performs step 433-1 again.

Further steps are contemplated, but it is useful to shortly return to the example: “when we had such noise the last time?”. Depending on the training, interface 230 may detect ambiguity, for example, in the following:

The word “we” raised by a single person points to multiple persons. The operator context would indicate that the persons would be the operators of the machine. As in (1), the query could be formulated to (here in pseudo-code) “noise in proximity of the machine, when?”
The term “such” identifies the noise that currently arrives from the machine, but the term may have a connotation (i.e., further meaning) in the sense that the operator who asks may not be pleased with that noise. Of course, the term “noise” already implies some discomfort. In other words, terms “such noise” or “noise” may be related to the subjective feeling of a person, but not to the objective presence of sound emissions. The trained interface could—case (3)—simply ask for a clarification by presenting: vibration sound? In step 433-1 the computer would then receive “yes, vibration”, or receive something else. (Of course, the computer does not have to use sophisticated rules of grammar, training may follow different approaches to detect the same).

### Further Implementation Aspects

Some of the questions/answers would occur more frequently then others. It is possible to implement translation functions (query interface 230) differently according to an expected use frequency.

Converting data to language (and vice versa) can be regarded as bidirectional mapping numerical values (for example, value in multi-variate or single-variate time-series) to statements in non-numerical formats.

The non-numerical formats can be language statements, statements in an artificially created language and the like.

For example, the time-series {0, 1, 2, 2, 3, 4} can be converted (or translated) to a statement like: “the values are increasing over time”. As the time interval between individual values is known (e.g., 60 seconds between each measurement), the overall time from the first to the last value can be considered as well: “the values are increasing over time-interval of 5 minutes”.

In notation by an artificial language, the statement could be given as “CONTINUE INCREASE”, “CONTINUE INCREASE during 5 minutes”, etc.

Statements can be created based on language components (such as words, phrases, etc.) that are understood be human operators. Techniques are available to mix numerical data into language statements.

An article by Xue and Salim explain data-to-text transformation with templates. (Hao Xue, Flora D. Salim: PROMPTCAST: A NEW PROMPT-BASED LEARNING PARADIGM FOR TIME SERIES FORECASTING), arXiv:2210.08964.

Converting (or translating) data between different forms (for use by the data modules) is domain-specific (cf. FIG. 5) and is also specific to operator contexts that are expected to appear. In other words, out-of-context data modules should not be candidates to be activated.

Task manager 240 will differentiate data modules not by simply letters A, B, C and D (as in the figure), but will apply technical identifications that are more appropriate (such as IDs, network addresses, service descriptor if the data modules are considered to provide services, etc.).

### Non-Interference with Control Information

As already mentioned, control communication and informative communication are separate topics.

As explained, assistant 200 can process data that primarily relates to controlling the machine. However, informative communication (to/from assistant 200) is not intended to control the machine directly. Even if assistant 200 generates a response that suggests the emergency stop (cf. 101 in FIG. 1), assistant 200 does not stop the machine. This is reserved for the human operator. In other words, assistant 200 may identify the technical state of the machine and communicate this technical state to operator 190 (in an operator-adapted language form). But it is up to operator 190 to react accordingly. Operator 190 decides, not assistant 200.

### Training

The description now shortly returns to FIG. 3. At the top line, the figure illustrates training activities. Training applies for implementations in that the modules are implemented by machine-learning tools, such as ANNs. Training can comprise:
steps 442 for training modules 220-A, 220-B, 220-C, 220-D (and many others data modules, not illustrated),
step 412 for training context detector 210, and
step 432 for training query interface 230.

The skilled person can implement the training. For example, both above-mentioned references by Schockaert et al explain training as well.

Training can be based on historical data, such a historical data with machine data in form of multi-variate time-series. Machine data represents machine parameters, data regarding materials and products, data regarding energy consumption, data regarding particular events.

To be used as training data, historical data can be annotated. In the example, it can be assumed that (i) similar noise occurred before (from machine 100, or from a machine of the same type, in the same sub-domain, cf. FIG. 4), (ii) vibrations and sounds had been captured as historical data (in time-series, that identify the time points), and that (iii) an operator who experienced the noise made an entry to a log file that the noise was “terrible” but that the machine continues to operate normally.

Training steps can be related with each other, to share data. For example, a bi-directional arrow between steps 412 and 432 symbolizes that training the context detector and training the query interface can use (or exchange) common historical data, such as context data (cf. 210-D in FIG. 2, in this training case historical data).

Dashed lines illustrate the use of trained modules: the trained context detector participates in step 413 (that is it main purpose), and may also participate in providing operator context to the function that implements translating 433-2, 453-1. Also, the trained query interface participates in steps 433-2 and 453-1 (in the main function to translate).

### Further Fictitious Examples

In a further, second example, operator 190 (who is the user of assistant 200) would raise a question as follows: “Currently, I see a sudden increase of the vibration amplitude since we changed material. Can you check if this phenomenon occurred in the past?”

Assistant 200 can decompose the question (by translating 433-2 to the query) into the following:
The variate {Xi} (in a multi-variate time-series {{X}}) that represents vibration is increasing, with a derivation (change over time) above a threshold derivation and during a minimum interval ΔT*NUMBER>THRESHOLD_DURATION.
The observation by the operator has to be taken as annotation (for further use, cf. training steps, for data modules), e.g., VIBRATION_INCREASE (or “sudden increase”).
There is a correlation to the parameter “material input”, the correlation is taken as annotation as well. In computer language that might look, here in the example of explanatory pseudo code, as INPUT_CHANGE--->VIBRATION_INCREASE.

There is task (i.e., a query) to be made to a data module with historical data that includes vibration data, that includes material data. The historical data is not to be used as training data, but as data to inform the operator (in the simplest case to answer YES, with an indication of the occurrence time in the past.)

Consulting the above-identified Radford et al. reference is useful as well.

In metaphorical words, assistant 200 operates likes a “questionnaire” with different fields by that a computer receives data from a user. By training (cf. step 432), query interface 230 has learned which “field” in the questionnaire has to be related with data.

In a further, third example, operator 190 (who is the user of assistant 200) would have the particular function of a service technician. Over time, cf. training step 412 in FIG. 3, context detector 210 would learn that service people frequently ask for maintenance data (“when was the last maintenance” “,” for when is the next maintenance scheduled?”). So the corresponding data modules would be activated.

In a fourth example, operator 190 would wear protective clothing. This example especially fit to machines that belong to metallurgical equipment, such as to furnaces. There is an opportunity to implement sensors to obtain health data (e.g., skin resistance, heart rate, body temperature, body vibrations, hearing threshold). Such data describe operator context as well. Upon detecting certain abnormalities (of the human operator, not of the machine), corresponding data modules can be activated. Eventually, if operator 190 faces a health problem, the data modules would have been activated already, for example to show operator 190 a way to leave the environment of the machine (but keeping the operation of the machine unchanged).

In the 5th example, assistant 200 serves as a surveillance tool to monitor operator 190, for example to detect drowsiness conditions or the like.

In the 6th example, operator 190 asks assistant 200 if it would be possible to visit a particular location of the machine (e.g., the top of a furnace), depending on the context, assistant 200 would possibly allow this, but would add a context-specific warning: “Yes, but use flame-resistant clothing”. The warning could be more specific and could even use a nick-name for that clothing (learned by training in step 432, FIG. 3).

In the 7th example, operator 190 asks assistant a question that triggers a conditional prediction, for example “what would happen if I would press this particular switch?”. The context detector would identify a particular switch (e.g., the switch for a particular motor) as context, and would activate data-modules that have—from a data perspective—a relation to that switch, such as data regarding the particular motor. By training, the computer has learned that a data module for prediction would have to be used and that part of the input data would be the state transition of that switch (e.g., the motor to be switched on).

In the 8th example, operator 190 asks assistant 200 a question that triggers a conditional prediction as well, but a prediction between time-points in the past. The question is example: “what would have happened if I would have pressed this particular switch a week ago?”. As in the 7th example, the context detector would identify a particular switch (e.g., the switch for a particular motor) as context, and would activate data-modules that have—from a data perspective—a relation to that switch, such as data regarding the particular motor. By training, the computer has learned that a data module for prediction would have to be used and that part of the input data would be the state transition of that switch (e.g., the motor to be switched on). Shifting the prediction to the past is simply a shift in time.

As mentioned above, there is a difference between control communication (operator/machine) and informative communication (operator/assistant) and assistant 200 supports decision making (for controlling). In a negative example, operator 190 may ask assistant 200 a question that is not related to controlling, for example, asks for the price of a spare part. As assistant 200 (and its data modules) has been trained with technical data (in the broadest sense), assistant 200 would deny answering.

### Multi-Variate Time-Series

The description occasionally refers to multi-variate time-series that represent pluralities of measurement data. In general, {{X}} stands for a multi-variate time-series, with i=1 to N variates {Xi}. Index i is the variate index, and N is the variate number. {{X}} comprises a plurality of single-variate time-series. The variates {Xi} are given in single-variate time-series. In alternative notation, the single-variate time-series can be given as a sequence of data samples.

M is the number of samples in an observation interval WINDOW (i.e., the temporal length of the time-series), and individual samples are identified by index m. The sampling interval has a duration of WINDOW=ΔT*M. ΔT stands for the sampling interval. ΔT can be the same for all i. This is convenient for illustration, but not required in reality. Different single-variate time-series can use different sampling intervals. For example, a temperature would be measured every minute, Δt=60 seconds. At every time point tm, data can be available that represent values for each variate Xi.

### Generic Computer

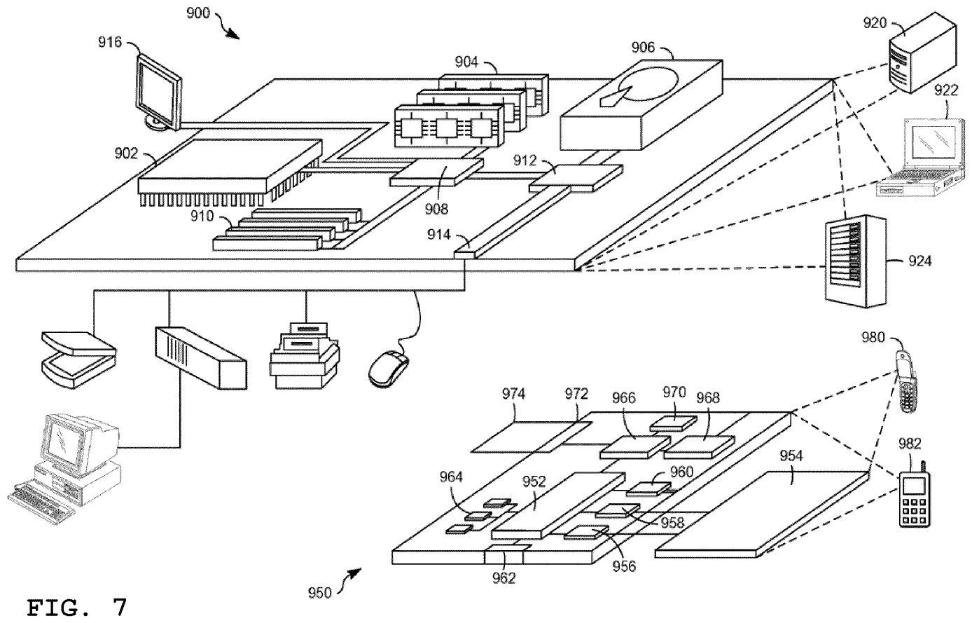

FIG. 7 illustrates an example of a generic computer device which may be used with the techniques described here. FIG. 7 is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, driving assistance systems or board computers of vehicles and other similar computing devices. For example, computing device 950 may be used as a frontend by a user (e.g., an operator of a blast furnace) to interact with the computing device 900. The components shown here, their connections and relationships, and their functions, are meant to be exemplary only, and are not meant to limit implementations of the disclosures described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 904, the storage device 906, or memory on processor 902.

The high-speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 964, expansion memory 984, or memory on processor 952 that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation-and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. Other components may be added to, or removed from, the described systems. Accordingly, other embodiments are within the scope of the following claims.

1. A computer-implemented method to communicate information regarding an industrial machine to an operator of the industrial machine, the method being executed by a computer and including the following steps:
by a context detector, detecting an operator context of the operator from context data that the context detector receives from the industrial machine, wherein the operator context is defined by the relation of the operator (190) to the industrial machine and by the function of the operator to control the industrial machine;
by a task manager, activating at least one data module from a plurality of data modules, according to the detected operator context, thereby the computer activating data modules for that the probability of being used is related to the operator context, wherein the step activating the at least one data module, comprises any of the following: loading the data module to the main memory of the computer, establishing a data connection to the industrial machine to receive machine data that represents current operation parameters of the industrial machine, associating model data with the to-be-activated data module, and instructing the data module to start operating;
upon a query interface receiving a question from the operator, translating the question to a query (340-Q) and directing the query to one of the previously activated data modules that is already running;
by one of the activated data modules, processing the query to obtain a response; and
translating the response to an answer and forwarding the answer to the operator.

2. The method according to claim 1, wherein the step activating the at least one data module comprises to communicatively couple a data source to the at least one data module, comprising any of the following:
coupling the data module to a collection of data regarding the past operation of the industrial machine if the data module is adapted to process data from the past; and
coupling the data module to a collection of data regarding the past operation of the industrial machine during a window interval if the data module is adapted to make predictions.

3. The method according to claim 1, wherein the step detecting the operator context of the operator by the context detector comprises to receive updated context data from the industrial machine for occasions, selected from the following:
determining that the operator of the industrial machine has changed to a different person;
determining that the operator of the industrial machine has performed a pre-defined activity with effect to the industrial machine;
determining that the operator has changed his or her physical location in relation to the industrial machine;
determining that the operator has escaped the location of the industrial machine;
determining that the operator wears clothing or has changed clothing; and
determining that the operator has changed the language of interaction with the operator interface of the industrial machine.

4. The method according to claim 1, wherein the steps translating the question to the query and translating the response to the answer are executed by keeping data that presents language statements, and wherein in step directing the query to one of the activated data modules comprises to direct the query to a data module that processes language statements.

5. The method according to claim 4, wherein directing the query comprises to direct the query to a data module that processes language statements that are selected from the following: language statements in natural language, language statements in artificial language, with the statements coded in alpha-numeric characters, and statements that are derivatives of language statements.

6. The method according to claim 1, wherein in the steps translating the question to the query and translating the response to the answer, the computer identifies a domain of the question and provides the answer in the same domain.

7. The method according to claim 1, wherein the context detector, in step detecting the operator context provides the operator context by classifying the context data.

8. The method according to claim 1, wherein after receiving the question from the operator by the query interface, and before translating the question to a query by the query interface, the method-executing computer checks the question for ambiguity, wherein for the absence of ambiguity, the computer continues with translating the question, and for the presence of ambiguity, the computer performs further steps, selected from the following:
(i) modifying the question according to operator context,
(ii) translating the question according to operator context, and
(iii) interacting with the operator to obtain further details in a follow-up question.

9. The method according to claim 1, wherein the task manager, in the step of activating at least one data module from a plurality of data modules also processes the state of the machine.

10. Using the method according to claim 1 including the step of communicating information regarding an industrial machine to an operator of the industrial machine in an assistance system.

11. A computer program product that, when loaded into a memory of a computer system and executed by at least one processor of the computer system, causes the computer system to perform the steps of a computer-implemented method according to claim 1.

12. A computer system comprising a plurality of modules which perform the steps of the computer-implemented method according to claim 1.

13. A computer-implemented assistance system —an assistant hereinafter—to communicate information regarding an industrial machine to an operator of the industrial machine, the assistant comprising:
a context detector that is adapted to detect an operator context of the operator from context data, wherein the context detector receives the context data from the industrial machine;
a plurality of data modules that are adapted to process a query to obtain a response;
a task manager that is adapted to activate at least one data module from the plurality of data modules, according to the detected operator context, so that the at least one data module is already running before receiving a query, wherein the task manager is adapted to activate the data module by being adapted to load the data module to the main memory of the computer, to establish a data connection to the industrial machine to receive machine data that represents current operation parameters of the industrial machine, to associate model data with the to-be-activated data module, or to instruct the data module to start operating; and
a query interface that is adapted to receive a question from the operator (190), to translate the question to the query and to direct the query to one of the activated data modules, wherein the query interface is also adapted to translate the response to an answer and to forward the answer to the operator.
